(19) United States
(12) Patent Application Publication
(10) Pub. No.: US 2025/0354826 A1
(43) Pub. Date: Nov. 20, 2025

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi, Aichi-ken (JP)

(72) Inventor: Mamoru TSUKAMOTO, Meguro-ko (JP)

(73) Assignee: TOYOTA JIDOSHA KABUSHIKI KAISHA, Toyota-shi, Aichi-ken (JP)

(21) Appl. No.: 19/205,061

(22) Filed: May 12, 2025

(30) Foreign Application Priority Data
May 14, 2024 (JP) 2024-078786

(51) Int. Cl. G01C 21/00; B60W 40/06; B60W 60/00; G06V 10/70; G06V 20/56

(52) U.S. Cl. CPC G01C 21/3819; B60W 40/06; B60W 60/001; G01C 21/3848; G06V 10/70; G06V 20/588; B60W 2420/403; B60W 2540/215; B60W 2552/20; B60W 2556/40; B60W 2556/50

(57) ABSTRACT

An information processing apparatus is an information processing apparatus that is mounted on a vehicle, the information processing apparatus comprising a processor configured to: acquire data via a sensor provided in the vehicle, estimate feature information by inputting the data to a first model that is a trained estimation model for estimating, as the feature information, information about an object for generating a road map, estimate topology information that is a topology of a lane of a road or a topology of the object and the lane by inputting the data to a second model that is a trained estimation model for estimating the topology information, and generate the road map of surroundings of the vehicle based on the feature information and the topology information.

### CROSS REFERENCE TO THE RELATED APPLICATION

This application claims the benefit of Japanese Patent Application No. 2024-078786, filed on May 14, 2024, which is hereby incorporated by reference herein in its entirety.

### BACKGROUND

### Technical Field

The present disclosure relates to map generation.

### Description of the Related Art

There is a technology for automatically generating a map. In this regard, Patent Document 1 discloses a mobile body that stores an advance map indicating a probability density of presence of a target object in each small region, that generates a current map indicating presence/absence of a target object in each small region, and that estimates a position of itself based on the advance map and the current map, for example.
[Patent Document 1]Japanese Patent Laid-Open No. 2023-173688
[Patent Document 2]Japanese Patent No. 7063310
[Patent Document 3]Japanese Patent Laid-Open No. 2019-168610

### SUMMARY

An object of the present disclosure is to generate a highly accurate peripheral map during traveling of a vehicle.

One aspect of an embodiment of the present disclosure is an information processing apparatus that is mounted on a vehicle, the information processing apparatus comprising a processor configured to:
acquire data via a sensor provided in the vehicle,
estimate feature information by inputting the data to a first model that is a trained estimation model for estimating, as the feature information, information about an object for generating a road map,
estimate topology information that is a topology of a lane of a road or a topology of the object and the lane by inputting the data to a second model that is a trained estimation model for estimating the topology information, and
generate the road map of surroundings of the vehicle based on the feature information and the topology information.

Another aspect of the embodiment of the present disclosure is an information processing method that is performed by an information processing apparatus that is mounted on a vehicle, the information processing method comprising:
a step of acquiring data via a sensor provided in the vehicle;
a step of estimating feature information by inputting the data to a first model that is a trained estimation model for estimating, as the feature information, information about an object for generating a road map;
a step of estimating topology information that is a topology of a lane of a road or a topology of the object and the lane by inputting the data to a second model that is a trained estimation model for estimating the topology information; and
a step of generating the road map of surroundings of the vehicle based on the feature information and the topology information.

Furthermore, as another mode, a program for causing a computer to perform the information processing method described above, or a non-transitory computer-readable storage medium storing the program can be cited.

According to the present disclosure, a highly accurate peripheral map can be generated during traveling of a vehicle.

### BRIEF DESCRIPTION OF THE DRAWINGS

FIG. 1 is a diagram illustrating an outline of processes performed by a vehicle-mounted apparatus;

FIG. 2 is a diagram for describing structural elements of a vehicle-mounted apparatus according to a first embodiment;

FIG. 3 is a flowchart of processes performed by a controller of the vehicle-mounted apparatus according to the first embodiment;

FIG. 4A is a diagram for describing feature information;

FIG. 4B is a diagram for describing topology information;

FIG. 5 is a flowchart of processes performed by a controller of a vehicle-mounted apparatus according to a second embodiment;

FIG. 6 is a diagram for describing structural elements of a vehicle-mounted apparatus according to a third embodiment;

FIG. 7 is a flowchart of processes performed by a controller of the vehicle-mounted apparatus according to the third embodiment; and

FIGS. 8A to 8C are diagrams for describing cases where it is determined that an error is detected by the controller of the vehicle-mounted apparatus.

### DESCRIPTION OF THE EMBODIMENTS

### (Outline)

An autonomous vehicle performs traveling control by using a peripheral map of a location where the autonomous vehicle is traveling.

For example, with respect to an autonomous vehicle, a high-definition map downloaded from an external apparatus is used for autonomous driving control of the vehicle. In this case, an appropriate high-definition map has to be downloaded each time according to a traveling area of the vehicle.

However, when a high-definition map is frequently downloaded, there is a problem that a communication volume between the external apparatus and the vehicle becomes high.

Furthermore, in a mode where the high-definition map is downloaded in advance to be used, depending on an update timing of the map, a current state of a road and the like and the high-definition map created in advance possibly do not match.

To reduce the communication volume between the external apparatus and the vehicle, and to reduce disagreement between the map to be used and a current state of a road, a vehicle-mounted apparatus preferably generates in real time a map of surroundings of a position where the vehicle is traveling, based on various pieces of sensor data acquired by the vehicle. This is because, when there is no need to download a high-definition map with a large amount of data from the external apparatus, the communication volume can be reduced. Furthermore, when a map that is generated in real time is used instead of a map that is created in advance, the current state of a road is better reflected in the map to be used for autonomous driving control.

The present disclosure in its one aspect provides an information processing apparatus that is mounted on a vehicle, the information processing apparatus comprising a processor configured to:
acquire data via a sensor provided in the vehicle,
estimate feature information by inputting the data to a first model that is a trained estimation model for estimating, as the feature information, information about an object for generating a road map,
estimate topology information that is a topology of a lane of a road or a topology of the object and the lane by inputting the data to a second model that is a trained estimation model for estimating the topology information, and
generate the road map of surroundings of the vehicle based on the feature information and the topology information.

The feature information is information about an object that is present on a road and that represents a specific meaning on a road map. More specifically, the feature information may be information about a road boundary line, a white line on a road (including a lane boundary line, a stop line and the like), a traffic light, or the like.

The first model is a trained estimation model for estimating the feature information. A trained estimation model is a certain machine learning model and is a model to which a certain amount of data is input to be reflected in a model structure. The first model is a model that outputs the feature information that is estimated from sensor data collected by a vehicle, when the sensor data is input.

The topology information is information indicating a topology of lanes or a topology of an object on or around a road and a lane. The object may be any of a plurality of types of objects representing specific meanings on a road map. The topology is a mathematical structure indicating a spatial relationship between target objects. That is, the topology information is information indicating a manner of coupling of lanes forming a road or a manner of coupling of an object on or around a road and a lane.

The second model is a trained estimation model for estimating the topology information. The second model is a model that outputs the topology information that is estimated from sensor data collected by a vehicle, when the sensor data is input.

The road map is a map displaying a road around the vehicle, a lane forming the road, and an object representing a specific meaning on the road (such as a white line, a stop line, or a traffic light).

The information processing apparatus according to an aspect of the present disclosure estimates the feature information and the topology information by inputting data collected by the vehicle during traveling to a plurality of trained estimation models. Moreover, the information processing apparatus according to an aspect of the present disclosure generates, in real time while traveling, the road map of surroundings of the vehicle based on the feature information and the topology information that are estimated.

By estimating and using the feature information to generate the road map, the information processing apparatus according to an aspect of the present disclosure can grasp an approximate shape of the road and can recognize a region where a vehicle can travel. By estimating and using the topology information to generate the road map, the information processing apparatus according to an aspect of the present disclosure can recognize a direction in which traveling can be performed and the like in relation to the lane of the road whose approximate shape is grasped. That is, the information processing apparatus according to an aspect of the present disclosure can recognize which lane allows traveling in which direction, whether a left turn or a right turn can be made, or whether a left turn or a right turn is prohibited, for example.

Accordingly, the information processing apparatus according to an aspect of the present disclosure can generate a map including information indicating a track along which the vehicle is to travel, which is not made clear just by the feature information based on the sensor data.

The information processing apparatus may further include a storage, and the processor may acquire the first model and the second model from an external apparatus and cause the first model and the second model that are acquired to be stored in the storage.

The estimation model may be updated (retrained) by an external apparatus as necessary. By enabling the updated estimation model to be acquired from outside, the information processing apparatus is allowed to use the latest estimation model as necessary.

Furthermore, the data may include information indicating a position of the vehicle, information indicating an orientation of the vehicle, and an image captured by a camera that is provided in the vehicle.

In the case where the position of the vehicle on the road map and the orientation of the vehicle relative to coordinates of the road map are known, a spatial position of an object recognized based on an image can be identified.

When such data is given to the estimation model as input data, the estimation model can estimate an accurate position of an object or the like. According to such a configuration, accuracy of the road map generated by the information processing apparatus can be increased.

Furthermore, the processor may generate a control parameter for controlling a behavior of the vehicle through autonomous driving, based on the road map that is generated.

According to such a configuration, the vehicle may be made to perform autonomous driving control, based on a map that is generated in real time. That is, autonomous driving control of the vehicle can be performed without downloading an existing high-definition map.

Furthermore, in a case where an error is detected in relation to the autonomous driving of the vehicle that is traveling, the processor may transmit the data including an image captured by a camera that is provided in the vehicle to a predetermined apparatus.

An error is any event that may obstruct autonomous driving.

For example, in a case where an error in autonomous driving is detected, the processor transmits image data where an event as a cause of the error is highly likely captured, to a center apparatus or the like that controls the vehicle.

According to such a configuration, an event as a cause of an error can be notified to the center apparatus or the like that controls the vehicle, and thus, analysis of a cause of an error can be supported.

Furthermore, in a case where an autonomous driving mode is cancelled by a user of the vehicle, or in a case where there is at least a first number of times of instances where the sensor does not acquire a predetermined number or more of pieces of the data during a first period of time, or in a case where a road map that is different by at least a predetermined proportion from an immediately preceding road map that has been generated is generated a second number of times or more during a second period of time, the processor may determine that the error is detected.

This is because, in the cases mentioned above, it can be estimated that there is a possibility that autonomous driving control that uses a road map that is automatically generated is not performed well or that a trouble is caused in relation to road map generation.

Furthermore, in a case where a predetermined sensor provided in the vehicle does not acquire global positioning system (GPS) information within a predetermined period of time, the processor may determine that the error is detected.

That is, in a case where position information on the vehicle is not grasped at a predetermined timing, the information processing apparatus according to an aspect of the present disclosure may assume that an error is caused in autonomous driving control.

Furthermore, the road map that is different by at least the predetermined proportion from the immediately preceding road map may be a road map that is different by at least a predetermined amount from the immediately preceding road map in terms of an estimation result regarding a white line from the first model or an estimation result regarding the topology of the lane from the second model.

Accordingly, in a case where there is an abnormality in the road map that is a result of generation, the information processing apparatus according to an aspect of the present disclosure can determine that there is occurrence of an error in autonomous driving control.

In a case where the error is detected a predetermined number of times or more, the processor may acquire the first model and the second model that are retrained from an external apparatus.

The first model and the second model that are retrained are models obtained by incrementally training the first model and the second model that are stored in the vehicle, for example.

In the case where the error mentioned above occurs a predetermined number of times or more, there is a possibility that the first model and the second model are not appropriate. In such a case, the retrained first and second models are preferably acquired from the external apparatus so that more appropriate models are used.

In the following, specific embodiments of the present disclosure will be described with reference to the drawings. A hardware configuration, a module configuration, a functional configuration, and the like described in each embodiment do not limit the technical scope of the disclosure thereto unless stated otherwise.

### First Embodiment

### [Outline of Processes Performed by Vehicle-Mounted Apparatus]

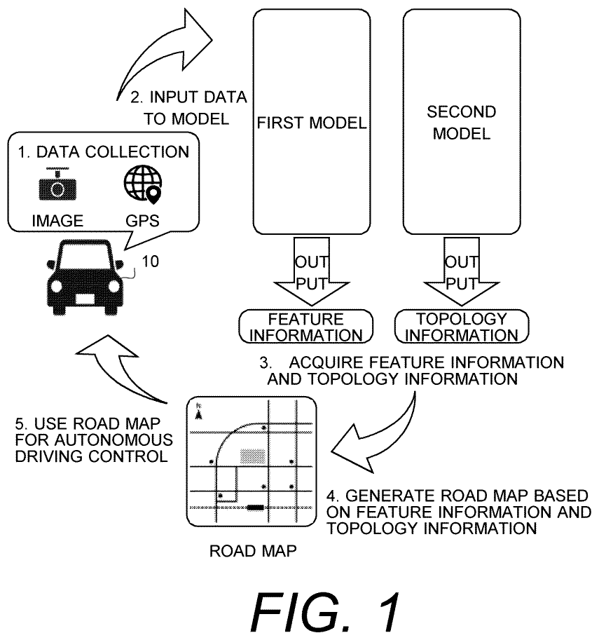

An outline of an information processing apparatus according to a first embodiment will be given with reference to FIG. 1. FIG. 1 is a diagram illustrating an outline of processes performed by a vehicle-mounted apparatus 100. The information processing apparatus according to the present embodiment is implemented as the vehicle-mounted apparatus 100, for example. The vehicle-mounted apparatus 100 is mounted on a vehicle 10 and provides functions such as a car navigation system to a user. The vehicle 10 is typically an autonomous vehicle and is capable of communicating an external apparatus via a wireless communication network (such as a cellular network).

The vehicle 10 generates a road map in real time based on data sensed by the subject vehicle, and autonomously travels by using the road map.

For example, the vehicle-mounted apparatus 100 is capable of acquiring, via the wireless communication network, an estimation model or the like to be used for generation of the road map. Furthermore, the vehicle 10 includes various sensors, and is capable of detecting things around the vehicle 10 while traveling. For example, the vehicle-mounted apparatus 100 is capable of estimating information necessary for generation of the road map by acquiring various pieces of data detected by the vehicle 10 and inputting the same to the estimation model.

The vehicle-mounted apparatus 100 acquires data detected by various sensors mounted on the vehicle 10. For example, various sensors may include a vehicle-mounted camera, a global positioning system (GPS) apparatus, and the like. For example, the vehicle-mounted apparatus 100 acquires image data captured by the vehicle-mounted camera, or position information (such as latitude/longitude information) acquired by the GPS apparatus.

Next, the vehicle-mounted apparatus 100 inputs various pieces of data that are collected, to the estimation model. There may be a plurality of estimation models, and types of data to be input to the estimation models may be different. The vehicle-mounted apparatus 100 may acquire one or more estimation models from an external apparatus in advance.

More specifically, the vehicle-mounted apparatus 100 inputs data to a first model that is an estimation model for estimating feature information, and a second model that is an estimation model for estimating topology information. The feature information is information about an object that is present on a road and that represents a specific meaning on the road map. For example, the feature information is an object such as a curb as a road boundary line, a white line on a road, a stop line, a traffic light, or a pedestrian crossing.

Furthermore, the topology information is information indicating a manner of coupling of lanes forming a road or of a lane of a road and an object on or around the road. The topology information can be said to be a lane-based network representation of a road (that is, network topology information on a road). More specifically, the topology information may express a connection relationship between lanes of a road or between a lane of a road and an object on or around the road using a node and an edge. The topology information indicating a connection relationship between lanes of a road is used to make a plan as to which lane is to be selected when a vehicle traveling on a certain lane is to travel to a destination. Furthermore, the topology information indicating a connection relationship between a lane of a road and an object is used to determine which object (for example, a traffic light) should be referred to by a vehicle traveling on a certain lane, at the time of autonomous driving or the like.

Next, the vehicle-mounted apparatus 100 acquires the feature information estimated by the first model, and the topology information estimated by the second model. Then, the vehicle-mounted apparatus 100 generates a road map of surroundings of the vehicle 10 based on the feature information and the topology information.

For example, based on the feature information, the vehicle-mounted apparatus 100 generates a map on which a road region where the subject vehicle can travel is mapped, and disposes other objects on the road region. Then, based on the topology information, the vehicle-mounted apparatus 100 adds, to the generated map, information indicating a track along which traveling can be performed.

Moreover, the vehicle-mounted apparatus 100 provides the generated road map to an autonomous driving function of the vehicle 10. The vehicle 10 can thus perform autonomous driving control based on the generated road map.

As described above, the vehicle-mounted apparatus 100 is capable of generating a road map based on information that is estimated by a trained estimation model that takes various pieces of data detected by the vehicle 10 as input. Accordingly, the vehicle-mounted apparatus 100 can automatically generate a map of surroundings during traveling of the vehicle 10.

### [Configuration of Vehicle-Mounted Apparatus]

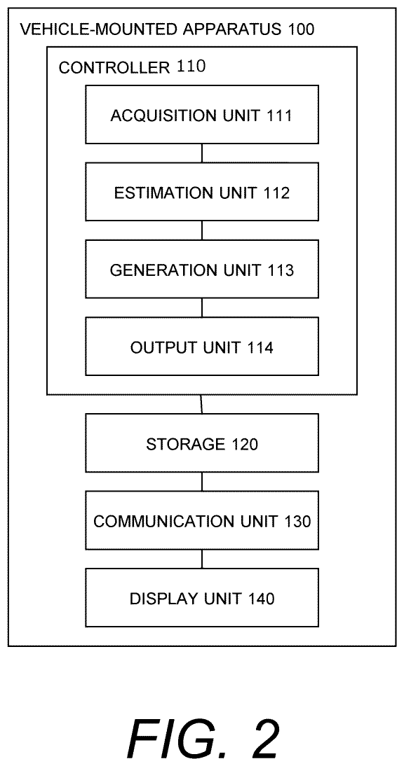

Next, a hardware configuration and a software configuration of each device forming the vehicle-mounted apparatus 100 will be described. FIG. 2 is a diagram for describing structural elements of the vehicle-mounted apparatus 100 according to the first embodiment.

The vehicle-mounted apparatus 100 may be a computer including processors (CPU, GPU, etc.), main memories (RAM, ROM, etc.), and auxiliary memories (EPROM, hard disk drive, removable medium, etc.). The auxiliary memory stores an operating system (OS), various programs, various tables and the like, and each function (software module) matching a predetermined object as described below may be implemented through execution of a program that is stored therein. However, one or some or all of functions may alternatively be implemented as a hardware module by a hardware circuit such as an ASIC or an FPGA.

The vehicle-mounted apparatus 100 includes a controller 110, a storage 120, a communication unit 130, and a display unit 140.

The controller 110 is implemented by a processor such as a central processing unit (CPU) or a graphics processing unit (GPU), and a memory. As functional modules, the controller 110 includes an acquisition unit 111, an estimation unit 112, a generation unit 113, and an output unit 114. These functional modules may be implemented by execution of a program by the controller 110.

The acquisition unit 111 communicates with an external apparatus via the communication unit 130 and acquires one or more trained estimation models. More specifically, the acquisition unit 111 acquires the first model that is a trained estimation model for estimating the feature information, and the second model that is a trained estimation model for estimating the topology information. The feature information is information for generating a road map and is about an object that represents a specific meaning on the road map. For example, an object is a curb as a road boundary line, a white line on a road, a stop line, a traffic light, or a pedestrian crossing. Furthermore, the topology information is information indicating a manner of connection between lanes of a road or between a lane of a road and an object on or around the road and is information indicating a spatial relationship between lanes or between an object and a lane by using a mathematical structure.

The acquisition unit 111 further acquires data acquired by various sensors of the vehicle 10. The various sensors of the vehicle 10 include the vehicle-mounted camera, the GPS apparatus, a gyrosensor, a speed sensor, an accelerometer, and a LiDAR (Laser Imaging Detection and Ranging), for example. More specifically, data to be acquired by the acquisition unit 111 may include information indicating a position of the vehicle 10 (latitude/longitude information, etc.), information indicating an orientation of the vehicle 10 (inclination (azimuth) relative to coordinate axes of the road map), and an image captured by a camera of the vehicle 10.

The estimation unit 112 inputs various pieces of data acquired by the acquisition unit 111 to a trained estimation model acquired by the acquisition unit 111, and estimates information to be used for generation of the road map. The estimation unit 112 periodically acquires data from the acquisition unit 111, and periodically estimates information to be used for generation of the road map.

More specifically, the estimation unit 112 estimates the feature information by inputting, to the first model, at least one of information indicating the position of the vehicle 10, information indicating the orientation of the vehicle 10, and an image captured by a camera of the vehicle 10. More specifically, the feature information may be information indicating a white line on a road, a traffic light, or the like.

Furthermore, the estimation unit 112 estimates the topology information by inputting, to the second model, at least one of information indicating the position of the vehicle 10, information indicating the orientation of the vehicle 10, and an image captured by a camera of the vehicle 10. More specifically, the topology information may be expressed by a matrix indicating a connection relationship between lanes.

The generation unit 113 generates a road map of surroundings of the vehicle 10 based on the feature information and the topology information estimated by the estimation unit 112. For example, the generation unit 113 generates a road map by determining an approximate shape of a road by recognizing road boundary line and the like based on the feature information, and by adding various objects to the approximate shape of the road that is determined. Then, based on the topology information, the generation unit 113 adds, to the road map, information such as a traveling direction on a lane of a road whose approximate shape is identified, a manner of connection to another lane, whether a right/left turn can be made from each lane at an intersection, and the like. The generation unit 113 periodically acquires the feature information and the topology information estimated by the estimation unit 112, and periodically generates the road map.

The output unit 114 outputs and provides the road map of surroundings of the vehicle 10 that is generated by the generation unit 113 to the autonomous driving function of the vehicle 10. Alternatively, the output unit 114 may output the generated road map to the display unit 140 or the like. The output unit 114 may output an updated road map each time according to a traveling position of the vehicle 10.

The storage 120 is a main memory such as a RAM or a ROM, or an auxiliary memory such as an EPROM, a hard disk drive or a removable medium. The auxiliary memory stores an operating system (OS), various programs, various tables and the like, and each function matching a predetermined object of each unit of the controller 110 can be implemented through execution of a program that is stored therein. However, one or some or all of functions may alternatively be implemented by a hardware circuit such as an ASIC or an FPGA.

The storage 120 stores data and the like that are used or generated by processes performed by the controller 110. The storage 120 may further store pieces of sensor data that are detected by various sensors of the vehicle 10 and acquired from the vehicle 10.

The communication unit 130 is a communication circuit that performs wireless communication. For example, the communication unit 130 may be a communication circuit that performs wireless communication using 4G (4th Generation) or may be a communication circuit that performs wireless communication using 5G (5th Generation). Moreover, the communication unit 130 may be a communication circuit that performs wireless communication using LTE (Long Term Evolution) or may be a communication circuit that performs communication using LPWA (Low Power Wide Area). Moreover, the communication unit 130 may be a communication circuit that performs wireless communication using Wi-Fi (registered trademark).

The display unit 140 is a display that displays an image and the like for providing information to a user. The display unit 140 may be a liquid crystal display or an organic electro-luminescence (EL) display. Furthermore, the display unit 140 may be implemented as a touch panel display. The display unit 140 displays the road map that is generated by the generation unit 113.

### [Processes of Vehicle-Mounted Apparatus]

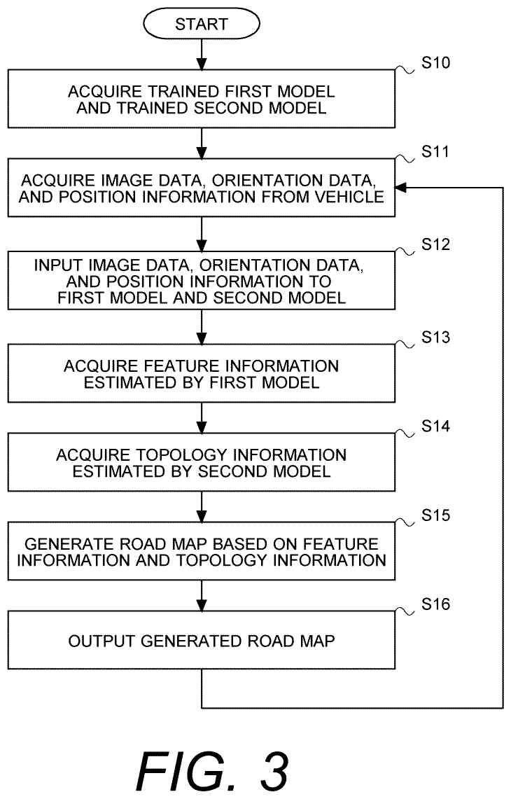

Next, details of processes that are performed by the vehicle-mounted apparatus 100 will be described. FIG. 3 is a flowchart of processes performed by the controller 110 of the vehicle-mounted apparatus 100 according to the first embodiment.

For example, the vehicle-mounted apparatus 100 starts processes described in FIG. 3 when a main switch of the vehicle is turned on. Alternatively, the vehicle-mounted apparatus 100 may start the processes described in FIG. 3 when a certain request is received from the user of the vehicle 10. A certain request may be an operation for causing the vehicle-mounted apparatus 100 to start route guidance to a destination of the user.

First, in step S10, the acquisition unit 111 acquires the first model and the second model that are trained estimation models. The acquisition unit 111 communicates with an external apparatus via the communication unit 130 and acquires the first model and the second model from the apparatus. The number of estimation models to be acquired by the acquisition unit 111 is not limited to two. The number of estimation models to be acquired by the acquisition unit 111 may be three or more or may be one in the case of an estimation model with which functions of both the first model and the second model are achieved.

In step S11, the acquisition unit 111 acquires from the vehicle 10, image data, orientation data, and position information on the vehicle 10 that are acquired by various sensors of the vehicle 10. The image data is an image captured by the vehicle-mounted camera of the vehicle 10. Furthermore, the orientation data is an angle (such as an azimuth angle indicating a traveling direction) indicating how inclined the orientation of the vehicle 10 is relative to coordinate axes of the road map generated by the vehicle-mounted apparatus 100. Furthermore, the position information on the vehicle 10 is latitude/longitude information indicating the position of the vehicle 10 that is acquired by the GPS apparatus of the vehicle 10, for example.

Next, in step S12, the estimation unit 112 inputs the image data, the orientation data, and the position information on the vehicle 10 to the first model and the second model. The estimation unit 112 may input each piece of data to each estimation model by processing the data to match a data format required by the estimation model.

Next, in step S13, the estimation unit 112 acquires the feature information that is estimated by the first model. As described above, the feature information is information indicating an object representing a specific meaning on a road. The feature information may include an object for determining a road region where the subject vehicle can travel.

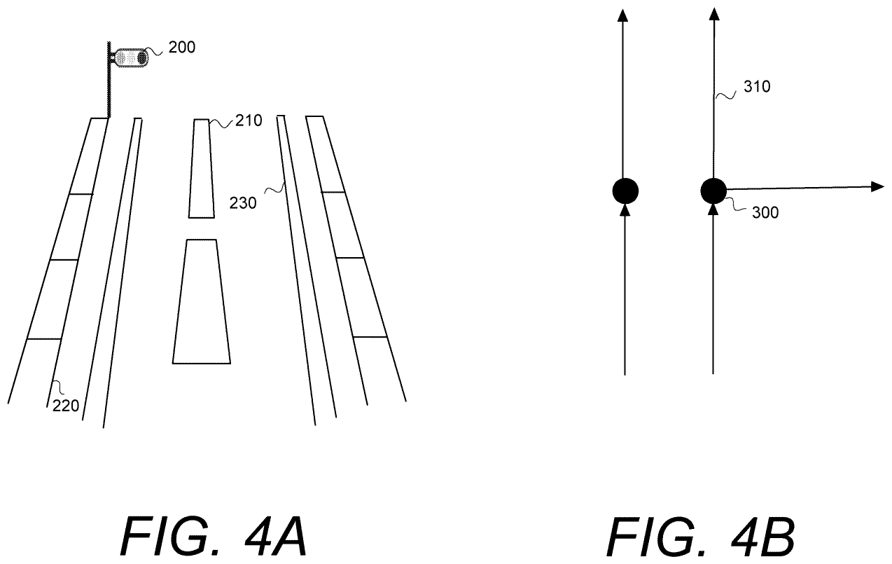

FIGS. 4A and 4B are diagrams for describing the feature information and the topology information. More specifically, as illustrated in FIG. 4A, the feature information is information indicating a traffic light 200 installed on a road, or a white line 210 drawn on the road, for example. Furthermore, the feature information may include a curb 220 of the road, or a white line 230 indicating a shoulder of the road. The estimation unit 112 can grasp the road region where the vehicle can travel, by recognizing the curb 220 of the road. Furthermore, the approximate shape of a lane forming the road, the number of lanes, and the like can be grasped by recognizing the white line 210 and the white line 230 indicating the shoulder of the road.

Moreover, the estimation unit 112 can grasp information necessary for the road map that is to be generated later, by recognizing an object, other than the white lines 210 and 230, that represents a specific meaning on the road, such as the traffic light 200 or the like. The traffic light 200 or the like is an object that represents a specific meaning on a road map and needs to be expressed on the road map. The feature information is not limited to information indicating the traffic light 200 or the like and may indicate any object that represents a specific meaning on a road map, such as a road sign.

Next, in step S14, the estimation unit 112 acquires the topology information that is estimated by the second model. As described above, the topology information is information indicating a topology of lanes of a road or of a lane of a road and an object, or in other words, a manner of coupling of lanes of a road or of a lane of a road and an object. As illustrated in FIG. 4B, the topology information is information indicating a node (such as a node 300) that is an end point of a section obtained by dividing a lane of a road into segments, and an edge (such as an edge 310) that connects two nodes 300. The illustrated topology information indicates that the edge 310 is connected to another edge via the node 300. In this manner, the topology information can indicate to which lane a lane of a road is connected.

Next, in step S15, the generation unit 113 generates a road map based on the feature information and the topology information estimated by the estimation unit 112. For example, the generation unit 113 may determine an approximate shape of a road around the vehicle 10 based on the feature information.

Then, based on the feature information, the generation unit 113 may add, to the approximate shape of the road, a structure on the road around the vehicle 10 or an object such as a white line. Moreover, based on the topology information, the generation unit 113 adds, to the road map, information such as a traveling direction on a lane of the road whose approximate shape is identified, a manner of connection to another lane, whether a right/left turn can be made from each lane at an intersection, and the like.

Next, in step S16, the output unit 114 outputs the road map generated by the generation unit 113 to the autonomous driving function of the vehicle 10. The autonomous driving function of the vehicle 10 uses data on the road map provided by the output unit 114 for automatic driving control of the vehicle 10.

After the process in step S16, the process proceeds again to step S11. The controller 110 periodically repeats the processes from step S11 to step S16. The controller 110 stops the processes when the main switch of the vehicle 10 is turned off or when a certain request is received from the user of the vehicle 10. A certain request may be an operation for causing the vehicle-mounted apparatus 100 to end route guidance to a destination of the user.

In the first embodiment, the estimation unit 112 estimates the feature information and the topology information by inputting acquired data to the estimation model. Then, the generation unit 113 generates a road map of surroundings of the vehicle 10 based on the feature information and the topology information that are estimated. The vehicle-mounted apparatus 100 can thereby generate a road map to which information that cannot be determined based solely on the feature information, such as a track along which the vehicle is to travel, is added.

### Second Embodiment

### [Outline of Processes Performed by Vehicle-Mounted Apparatus]

In the first embodiment, the vehicle-mounted apparatus 100 outputs, to the autonomous driving function of the vehicle 10, a road map of surroundings of the vehicle 10 that is generated in real time according to traveling of the vehicle 10. The vehicle 10 performs autonomous driving control of the vehicle 10 based on the road map that is output. However, the road map does not necessarily have to be used solely for autonomous driving and may be used for other services. Accordingly, in a second embodiment, the vehicle-mounted apparatus 100 transmits the road map of surroundings of the vehicle 10 that is generated in real time to the storage 120 of the vehicle-mounted apparatus 100, an external server apparatus, or the like.

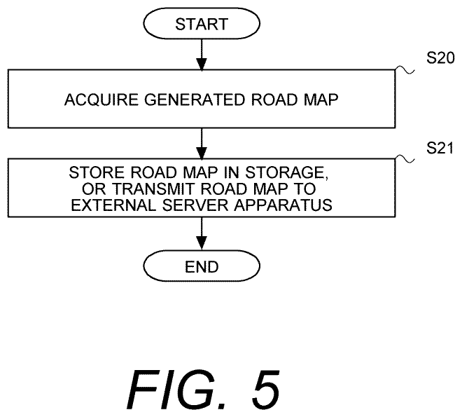

FIG. 5 is a flowchart of processes performed by the controller 110 of the vehicle-mounted apparatus 100 according to the second embodiment. After the process in step S15 in FIG. 3, the vehicle-mounted apparatus 100 starts step S20 in FIG. 5.

First, in step S20, the output unit 114 acquires the road map of surroundings of the vehicle 10 that is generated by the generation unit 113. The output unit 114 may acquire, as the road map of surroundings of the vehicle 10, data indicating the lane topology of the road and the feature information, instead of data in a format to be displayed as an image.

Next, in step S21, the output unit 114 causes the acquired road map to be stored in the storage 120. Alternatively, the output unit 114 transmits the acquired road map to an external server apparatus.

In the second embodiment, the vehicle-mounted apparatus 100 causes the storage 120 to store a road map that is generated in real time according to traveling of the vehicle 10 or transmits the road map to an external server apparatus. The vehicle-mounted apparatus 100 thus enables a latest road map of surroundings of the vehicle 10 to be used for other services.

### Third Embodiment

In the second embodiment, the vehicle-mounted apparatus 100 generates a control parameter for autonomous driving of the vehicle 10 based on a generated road map and supports autonomous driving control of the vehicle 10. However, it is conceivable that some kind of error occurs in autonomous driving control supported by the vehicle-mounted apparatus 100. An error is some kind of event that obstructs continuance of autonomous driving control. In such a case, there is a possibility that there is a problem with the road map that is generated by the vehicle-mounted apparatus 100. Accordingly, in a third embodiment, in a case where occurrence of an error is determined in relation to autonomous driving of the vehicle 10, the vehicle-mounted apparatus 100 takes a predetermined measure to increase accuracy of autonomous driving. In the present embodiment, as predetermined measures for increasing accuracy of autonomous driving, there are cited (1) transmission of data acquired by the subject vehicle to an external apparatus for inspection, and (2) acquisition of a latest estimation model from an external apparatus.

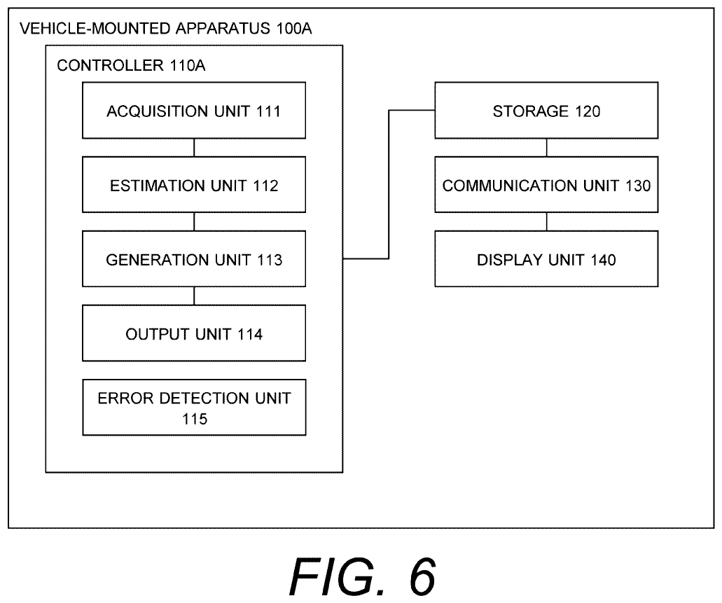

FIG. 6 is a diagram for describing structural elements of a vehicle-mounted apparatus 100A according to the third embodiment. The vehicle-mounted apparatus 100A includes a controller 110A, the storage 120, the communication unit 130, and the display unit 140. Of the structural elements of the vehicle-mounted apparatus 100A, those that are the same as the structural elements of the vehicle-mounted apparatus 100 will not be described.

The controller 110A includes the acquisition unit 111, the estimation unit 112, the generation unit 113, the output unit 114, and an error detection unit 115.

The error detection unit 115 determines whether there is occurrence of an event that obstructs autonomous driving of the vehicle 10. In the present embodiment, occurrence of an event that obstructs autonomous driving will be referred to as error.

The error detection unit 115 determines that an error is detected, in a case where a user of the vehicle 10 cancels an autonomous driving mode. Furthermore, the error detection unit 115 determines that an error is detected, in a case where there is at least a first number of times of instances where a sensor does not acquire a predetermined number or more of pieces of the data during a first period of time. Furthermore, the error detection unit 115 determines that an error is detected, in a case where a road map that is different by at least a predetermined proportion from an immediately preceding road map that has been generated is generated a second number of times or more during a second period of time.

Additionally, three events that obstruct autonomous driving are cited above, but other events may also be detected as the error.

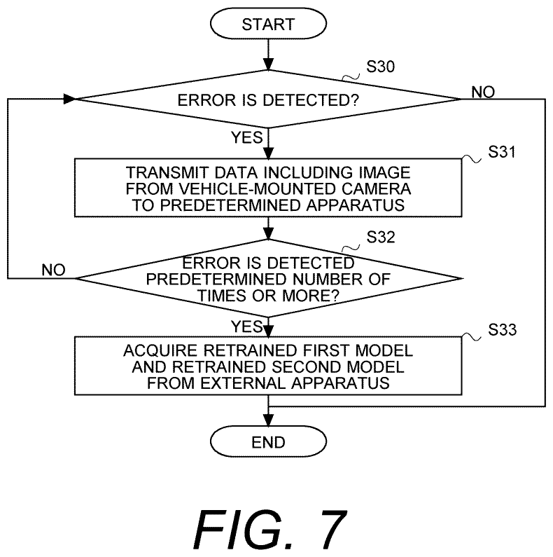

FIG. 7 is a flowchart of processes performed by the controller 110A of the vehicle-mounted apparatus 100A according to the third embodiment. The vehicle-mounted apparatus 100A starts processes in FIG. 7 separately from the processes in FIGS. 3 and 5. The processes in FIG. 7 are performed in parallel with the processes in FIGS. 3 and 5.

First, in step S30, the error detection unit 115 determines whether an error is detected during autonomous driving of the vehicle 10. A positive determination is made in the present step in a case where the error detection unit 115 determines that an error is detected.

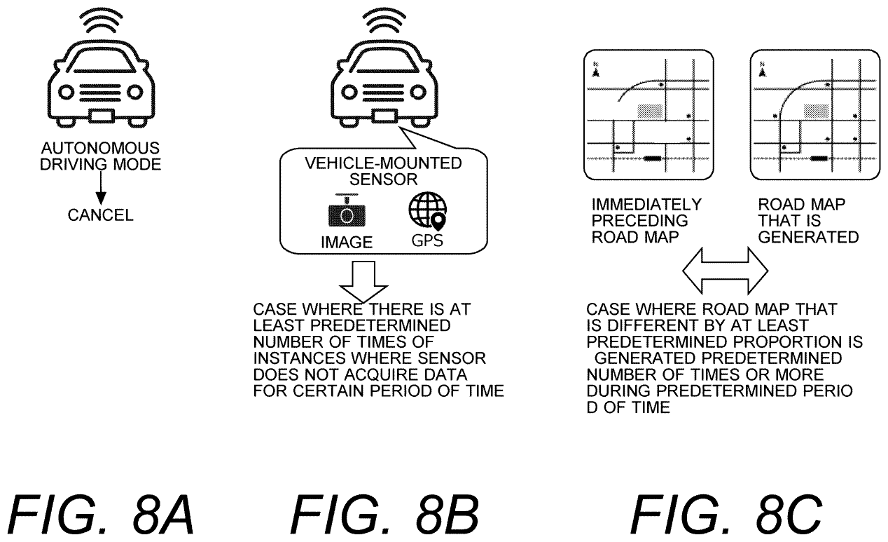

Conditions under which the error detection unit 115 determines that an error is detected will be described in detail. FIGS. 8A to 8C are diagrams for describing conditions under which the controller 110A of the vehicle-mounted apparatus 100A determines that an error is detected. As illustrated in FIG. 8A, the error detection unit 115 determines that an error in autonomous driving of the vehicle 10 is detected, in a case where the autonomous driving mode of the vehicle 10 is cancelled by a user. Cancellation of the autonomous driving mode may be temporary cancellation and may be an intervention in a driving operation by a user. In the case where the autonomous driving mode of the vehicle 10 is cancelled by a user, there is a possibility of occurrence of some kind of trouble in the autonomous driving control.

Furthermore, as illustrated in FIG. 8B, the error detection unit 115 determines that an error in autonomous driving of the vehicle 10 is detected, in a case where there is at least a predetermined number of times of instances where one of various sensors mounted in the vehicle 10 does not acquire data for a certain period of time. The various sensors may be the vehicle-mounted camera or the GPS apparatus, for example. Furthermore, data to be acquired by the various sensors may be image data, GPS information, or the like. In the case where the vehicle 10 fails to acquire data necessary for autonomous driving a predetermined number of times or more, there is a possibility of occurrence of some kind of trouble in the autonomous driving control.

Furthermore, as illustrated in FIG. 8C, the error detection unit 115 determines that an error in autonomous driving of the vehicle 10 is detected, in a case where a road map that is different by at least a predetermined proportion from an immediately preceding road map that has been generated is generated at least a predetermined number of times or more during a predetermined period of time. A road map that is different by at least a predetermined proportion from an immediately preceding road map that has been generated is a road map as described below, for example.
(1) A road map that is different by at least a predetermined amount from an immediately preceding road map that has been generated, in terms of an estimation result regarding a road region on a road map according to the first model.
(2) A road map that is different by at least a predetermined amount from an immediately preceding road map that has been generated, in terms of an estimation result regarding the topology of a lane of a road on a road map according to the second model.

In the case where a road map that is different by at least a predetermined proportion from an immediately preceding road map is generated, it can be presumed that there is a problem with one of the immediately preceding road map and the road map that is currently generated. When such a state occurs a predetermined number of times or more within a predetermined period of time, there is a possibility of occurrence of some kind of trouble in the autonomous driving control.

A description will be given by referring back to FIG. 7.

In the case where a positive determination is made in the present step, the process proceeds to step S31.

In the case where a negative determination is made in the present step, the processes are ended.

In the case where the process proceeds to step S31, the output unit 114 transmits data including an image from the vehicle-mounted camera to a predetermined external apparatus. The output unit 114 may transmit at least one of the image data, the orientation data, the position information on the vehicle 10, and the like to the predetermined external apparatus. After transmission, the acquisition unit 111 may acquire a result of analysis, by the predetermined external apparatus, of the data transmitted by the output unit 114. Then, the output unit 114 may reflect the analysis result acquired by the acquisition unit 111 in generation of the control parameter for autonomous driving in the process in step S21 in FIG. 5.

Next, in step S32, the error detection unit 115 determines whether an error in the autonomous driving of the vehicle 10 is detected a predetermined number of times or more. In the case where the error detection unit 115 determines that an error in the autonomous driving of the vehicle 10 is detected a predetermined number of times or more, a positive determination is made in the present step.

In the case where the positive determination is made in the present step, the process proceeds to step S33.

In the case where a negative determination is made in the present step, the process proceeds to step S30.

In the case where the process proceeds to step S33, the acquisition unit 111 acquires a latest first model and a latest second model from an external apparatus. The first model and the second model that are to be acquired may be models that are obtained by retraining (incrementally training) the first model and the second model held by the subject vehicle. The acquisition unit 111 re-acquires retrained estimation models in relation to the trained estimation models acquired in step S10 in FIG. 3. The estimation models may be models that are retrained based on the data transmitted in step S31.

After step S33, the estimation models acquired in the present step may be reflected in the processes in step S11 and subsequent steps in FIG. 3.

In the third embodiment, in the case where the vehicle-mounted apparatus 100A detects an error in the autonomous driving of the vehicle 10, data acquired by various sensors of the vehicle 10 is transmitted to the predetermined external apparatus. Moreover, in the case where an error is detected by the vehicle-mounted apparatus 100A a predetermined number of times or more, retrained estimation models are re-acquired from the predetermined external apparatus. Accordingly, in the case where there is occurrence of an error in the autonomous driving of the vehicle 10, the vehicle-mounted apparatus 100A corrects the road map that is generated, and thereby supports normal autonomous driving.

### (Other Modifications)

The above embodiments are mere examples, and the present disclosure can be appropriately changed and implemented within a range not departing from the spirit thereof.

In the embodiments described above, a trained estimation model is acquired from an external apparatus, but the vehicle-mounted apparatus 100 may instead hold the estimation model in advance and perform training or retraining of the estimation model by itself.

The present disclosure can also be realized by supplying a computer program implementing the functions described in the above embodiment to a computer, and one or more processors included in the computer read out and perform the program. Such computer programs may be provided to a computer by a non-transitory computer-readable storage medium connectable to a system bus of the computer or may be provided to the computer over a network. A non-transitory computer-readable storage medium includes, for example, any type of disk, such as a magnetic disk (floppy disk, hard disk drive (HDD), etc.), an optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. An information processing apparatus that is mounted on a vehicle, the information processing apparatus comprising a processor configured to:
acquire data via a sensor provided in the vehicle,
estimate feature information by inputting the data to a first model that is a trained estimation model for estimating, as the feature information, information about an object for generating a road map,
estimate topology information that is a topology of a lane of a road or a topology of the object and the lane by inputting the data to a second model that is a trained estimation model for estimating the topology information, and
generate the road map of surroundings of the vehicle based on the feature information and the topology information.

2. The information processing apparatus according to claim 1, further comprising a storage, wherein
the processor
acquires the first model and the second model from an external apparatus, and
causes the first model and the second model that are acquired to be stored in the storage.

3. The information processing apparatus according to claim 1, wherein the data includes information indicating a position of the vehicle, information indicating an orientation of the vehicle, and an image captured by a camera that is provided in the vehicle.

4. The information processing apparatus according to claim 1, wherein the processor generates a control parameter for controlling a behavior of the vehicle through autonomous driving, based on the road map that is generated.

5. The information processing apparatus according to claim 4, wherein, in a case where an error is detected in relation to the autonomous driving of the vehicle that is traveling, the processor transmits the data including an image captured by a camera that is provided in the vehicle to a predetermined apparatus.

6. The information processing apparatus according to claim 5, wherein, in a case where an autonomous driving mode is cancelled by a user of the vehicle, or in a case where there is at least a first number of times of instances where the sensor does not acquire a predetermined number or more of pieces of the data during a first period of time, or in a case where a road map that is different by at least a predetermined proportion from an immediately preceding road map that has been generated is generated a second number of times or more during a second period of time, the processor determines that the error is detected.

7. The information processing apparatus according to claim 5, wherein, in a case where a predetermined sensor provided in the vehicle does not acquire global positioning system (GPS) information within a predetermined period of time, the processor determines that the error is detected.

8. The information processing apparatus according to claim 6, wherein the road map that is different by at least the predetermined proportion from the immediately preceding road map is a road map that is different by at least a predetermined amount from the immediately preceding road map in terms of an estimation result regarding a white line from the first model or an estimation result regarding the topology of the lane from the second model.

9. The information processing apparatus according to claim 5, wherein, in a case where the error is detected a predetermined number of times or more, the processor acquires the first model and the second model that are retrained from an external apparatus.

10. An information processing method that is performed by an information processing apparatus that is mounted on a vehicle, the information processing method comprising:
a step of acquiring data via a sensor provided in the vehicle;
a step of estimating feature information by inputting the data to a first model that is a trained estimation model for estimating, as the feature information, information about an object for generating a road map;
a step of estimating topology information that is a topology of a lane of a road or a topology of the object and the lane by inputting the data to a second model that is a trained estimation model for estimating the topology information; and
a step of generating the road map of surroundings of the vehicle based on the feature information and the topology information.

11. The information processing method according to claim 10, further comprising:
a step of acquiring the first model and the second model from an external apparatus; and
a step of causing the first model and the second model that are acquired to be stored in a storage.

12. The information processing method according to claim 10, wherein the data includes information indicating a position of the vehicle, information indicating an orientation of the vehicle, and an image captured by a camera that is provided in the vehicle.

13. The information processing method according to claim 10, further comprising a step of generating a control parameter for controlling a behavior of the vehicle through autonomous driving, based on the road map that is generated.

14. The information processing method according to claim 13, further comprising a step of transmitting the data including an image captured by a camera that is provided in the vehicle to a predetermined apparatus, in a case where an error is detected in relation to the autonomous driving of the vehicle that is traveling.

15. The information processing method according to claim 14, further comprising a step of determining that the error is detected, in a case where an autonomous driving mode is cancelled by a user of the vehicle, or in a case where there is at least a first number of times of instances where the sensor does not acquire a predetermined number or more of pieces of the data during a first period of time, or in a case where a road map that is different by at least a predetermined proportion from an immediately preceding road map is generated a second number of times or more during a second period of time.

16. The information processing method according to claim 14, wherein, in a case where a predetermined sensor provided in the vehicle does not acquire global positioning system (GPS) information within a predetermined period of time, detection of the error is determined.

17. The information processing method according to claim 15, wherein the road map that is different by at least the predetermined proportion from the immediately preceding road map is a road map that is different by at least a predetermined amount from the immediately preceding road map in terms of an estimation result regarding a white line from the first model or an estimation result regarding the topology of the lane from the second model.

18. The information processing method according to claim 14, further comprising a step of acquiring the first model and the second model that are retrained from an external apparatus, in a case where the error is detected a predetermined number of times or more.

19. A non-transitory storage medium storing a program for causing a computer to perform the information processing method according to claim 10.
